(19) United States
(12) Patent Application Publication
(10) Pub. No.: US 2014/0258092 A1
(43) Pub. Date: Sep. 11, 2014

(54) SYSTEMS AND METHODS FOR ANALYZING FINANCIAL ACCOUNTS AND BUSINESS EFFORTS BASED ON LENDER INFORMATION

(71) Applicants: Hannes M. Jouhikainen, Arlington, VA (US); Luke A. Hammock, Washington, DC (US); Janusz M. Niczyporuk, Vienna, VA (US)

(72) Inventors: Hannes M. Jouhikainen, Arlington, VA (US); Luke A. Hammock, Washington, DC (US); Janusz M. Niczyporuk, Vienna, VA (US)

(73) Assignee: CAPITAL ONE FINANCIAL CORPORATION, McLean, VA (US)

(21) Appl. No.: 14/089,251

(22) Filed: Nov. 25, 2013

Related U.S. Application Data
(60) Provisional application No. 61/776,270, filed on Mar. 11, 2013.

(51) Int. Cl. G06Q 40/00

(52) U.S. Cl. CPC G06Q 40/025
USPC 705/38

(57) ABSTRACT

The disclosed embodiments include methods and systems for assessing financial account requests. In one embodiment, a method is disclosed that includes receiving a request from a borrower for a first financial account offered by a financial service provider. The method may also include collecting first lender information associated with the borrower and a first lender, where the lender information includes information associated with at least one first lender financial account offered by the first lender. In certain aspects, the method may further include analyzing the request based on the lender information and determining whether to approve the request for the first financial account based on the analysis of the request.

### CROSS REFERENCE TO RELATED APPLICATION

This disclosure claims priority under 35 U.S.C. §119 to U.S. provisional patent application No. 61/776,270, filed on Mar. 11, 2013. and entitled “Systems and Methods for Analyzing Financial Accounts and Business Efforts Based on Lender Information,” which is incorporated herein by reference in its entirety.

### TECHNICAL FIELD

The present disclosure relates generally to financial service account management technologies and, in particular, to methods and systems for analyzing financial accounts and business efforts based on lender information.

### BACKGROUND

Financial service providers spend many millions of dollars every year to provide loans and other financial service products to consumers and businesses. Decisions whether to provide those products to borrowers are typically based on many indicators of borrowers' creditworthiness, such as a credit risk score (e.g., FICO score), income, number of loans outstanding, number of times lending has been requested in the past 30 days, etc.

Some of the indicators may relate to borrowers' existing or previous lending arrangements with other lenders. This information may be typically provided by third-party credit bureaus. While the information provided by credit bureaus may be helpful in assessing the credit worthiness of a borrower, credit bureaus typically treat all lenders the same and do not provide information as to how important or how much the financial service provider should weigh the lending relationships between borrowers and lenders. For example, a financial service provider that is assessing a potential borrower's loan request may receive from a credit bureau the average credit card limit extended to the borrower by all lenders (e.g., $4,000) and a maximum credit card limit the borrower has at their disposal (e.g., $7,000). However, the credit bureau information does not inform the financial service provider which lenders combine to give the borrower the average of $4,000 line of credit and which lender has given them a $7,000 line of credit.

The disclosed embodiments include methods and systems that address the challenges associated processing financial service account requests. In one embodiment, a financial service provider may collect lender information associated with financial service accounts (e.g., lines of credit, loans, etc.) held by a borrower with one or more other lenders. The financial service account provider may be configured to execute processes that determine whether to approve or decline a financial service account to the borrower based on the collected lender information. In other embodiments, the financial service provider may collect lender information associated with financial service accounts that other lender(s) declined for the borrower. Other aspects of the disclosed embodiments are set forth below in this disclosure.

### SUMMARY

The disclosed embodiments include a system for assessing financial account application requests. In one embodiment, the system may include one or more memory devices storing software instructions and one or more processors configured to execute the software instructions to receive a request from a borrower for a first financial account offered by a financial service provider. The one or more processors may also be configured to collect first lender information associated with the borrower and a first lender, where the lender information includes information associated with at least one first lender financial account offered by the first lender to the borrower. Further, the one or more processors may be configured to analyze the request based on the lender information, and determine whether to approve the request for the first financial account based on the analysis.

The disclosed embodiments may also include a computer-implemented method for assessing financial account application requests. The method may include, for example, receiving a request from a borrower for a first financial account offered by a financial service provider and collecting first lender information associated with the borrower and a first lender, where the lender information includes information associated with at least one first lender financial account offered by the first lender. The method may also include analyzing the request based on the lender information and determining whether to approve the request for the first financial account based on the analysis of the request.

It is to be understood that both the foregoing general description and the following detailed description are exemplary and explanatory only and are not restrictive of the disclosed embodiments, as claimed.

The accompanying drawings, which are incorporated in and constitute a part of this specification, illustrate disclosed embodiments and, together with the description, serve to explain the disclosed embodiments.

### BRIEF DESCRIPTION OF THE DRAWINGS

FIG. 1 is a block diagram of an exemplary system, consistent with disclosed embodiments.

FIG. 2 is a block diagram of another exemplary system, consistent with disclosed embodiments.

FIG. 3 is a block diagram of an exemplary system process flow associated with collecting lender information, consistent with disclosed embodiments.

FIG. 4 is a flowchart of an exemplary credit application process, consistent with disclosed embodiments.

FIG. 5 is a flowchart of an exemplary lender information collection process, consistent with disclosed embodiments.

FIG. 6 is a flowchart of another exemplary lender information collection process, consistent with disclosed embodiments.

FIG. 7 is a flowchart of another exemplary lender information collection process, consistent with disclosed embodiments.

FIG. 8 is a flowchart of another exemplary lender information collection process, consistent with disclosed embodiments.

FIG. 9 is a flowchart of an exemplary lender information analysis process, consistent with disclosed embodiments.

FIG. 10 is a diagram of an exemplary data structure configuration, consistent with disclosed embodiments.

FIG. 11 is a diagram of an exemplary system, consistent with disclosed embodiments.

FIG. 12 is a flowchart of an exemplary credit profile generation/update process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

The disclosed embodiments include methods, systems, and articles of manufacture that may be configured to assess, for example, requests for financial accounts based on, for example, financial service account information associated with other lenders. For example, certain disclosed embodiments may be configured to collect lender information reflecting information regarding financial accounts that other lenders have declined for a borrower. In other aspects, the lender information may include information regarding financial accounts that other lenders have approved for a borrower. In other embodiments, the lender information may include, for example, repayment history, frequency of financial accounts granted by certain lenders, financial account utilization information, or any other information associated with financial accounts, credit history, etc. associated with other lender(s) and specific borrower(s). The disclosed embodiments may include systems, methods, and articles of manufacture that analyze collected lender information to assess and determine whether to approve, decline, or modify a financial service account request for a particular borrower, based on collected lender information associated with the borrower. Other aspects of the disclosed embodiments are disclosed below, and the above examples are not intended to be limiting.

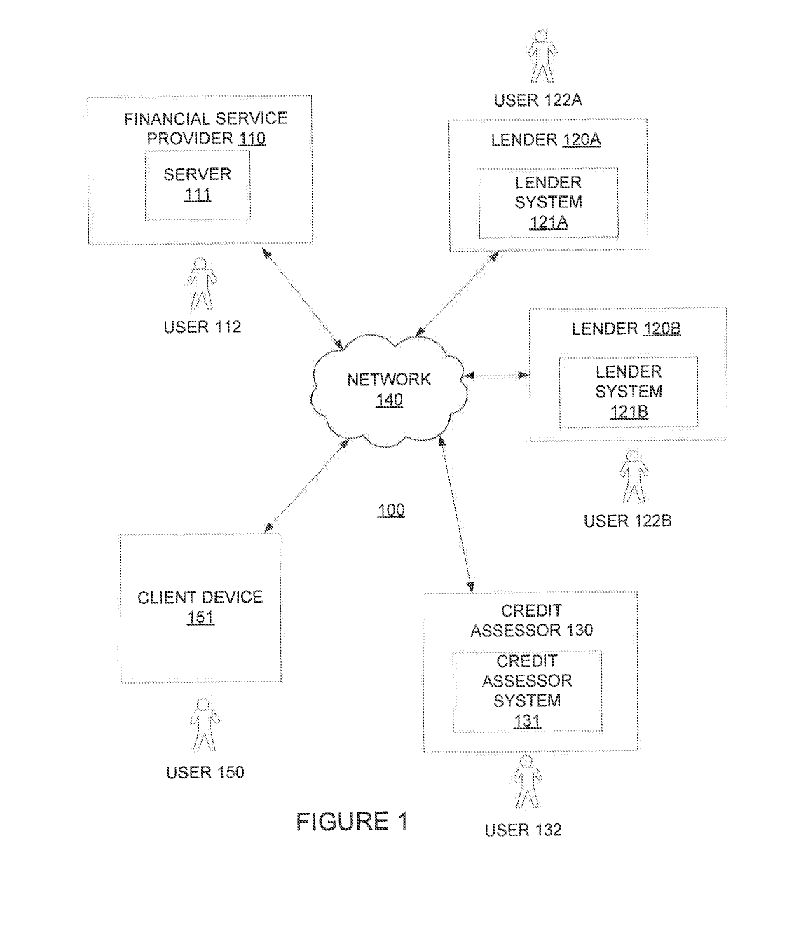

FIG. 1 is a block diagram of an exemplary system 100 for performing one or more operations, consistent with the disclosed embodiments. In one embodiment, system 100 may include a financial service provider 110, lenders 120A, 120B, credit assessor 130, client device 151, and network 140. The components and arrangement of the components included in system 100 may vary. Thus, system 100 may further include other components that perform or assist in the performance of one or more processes consistent with the disclosed embodiments.

Financial service provider 110 may be an entity that provides, manages, maintains, etc. financial services and financial service accounts. For example, financial service provider 110 may be a bank, credit card issuer, or other type of financial service entity that generates, provides, manages, and/or maintains financial service accounts for one or more users. Financial service accounts may include, for example, credit card accounts, loan accounts, checking accounts, savings accounts, reward accounts, and any other type of financial service account known to those skilled in the art. In certain embodiments, financial service provider 110 may be a lender that offers one or more types of lines of credits, loans, etc. for businesses and/or individuals. Financial service provider 110 may include infrastructure and components that are configured to generate, offer, manage, and/or provide financial service accounts, such as lines of credit, loans, and the like.

In one embodiment, financial service provider 110 may include one or more computing systems that are configured to execute software instructions stored on one or more memory devices to perform one or more operations consistent with the disclosed embodiments. In one embodiment, financial service provider 110 may include server 111. Server 111 may be one or more computing devices configured to execute software instructions stored in memory to perform one or more processes consistent with the disclosed embodiments. For example, server 111 may include one or more memory device(s) storing data and software instructions and one or more processor(s) configured to use stored data and execute the software instructions to perform server-based functions and operations known to those skilled in the art. Server 111 may also be configured to execute stored software instructions to perform operations associated with collecting credit information relating to borrowers who request approval for financial service accounts offered by financial service provider 110 and/or other lenders separate from financial service provider 110. In certain embodiments, the borrowers may or may not be customers of financial service provider 110. In one embodiment, the credit information may include information relating to financial accounts granted, denied, and/or managed by other lenders for the borrowers.

Server 111 may be a general purpose computer, a mainframe computer, or any combination of these components. In certain embodiments, server 111 (or a system including server 111) may be configured as a particular apparatus, system, and the like based on the storage, execution, and/or implementation of the software instructions that perform one or more operations consistent with the disclosed embodiments. Server 111 may be standalone, or it may be part of a subsystem, which may be part of a larger system. For example, server 111 may represent distributed servers that are remotely located and communicate over a network (e.g., network 140) or a dedicated network, such as a LAN, for financial service provider 110.

Server 111 may include (or connect to) one or more storage devices configured to store data and/or software instructions used by one or more processors of server 111 to perform operations consistent with disclosed embodiments. For example, server 111 may include memory configured to store one or more software programs that perform several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides web site(s) that are accessible over network 140. In other aspects, financial server provider 110 may connect separate web server(s) or similar computing devices that generate, maintain, and provide web site(s) for financial service provider 110. In one aspect, users, such as a borrower, may access the website(s) provided by or associated with financial service provider 110 to review applications for financial account(s) (e.g., lines of credit, credit cards, loans, etc.) offered by financial service provider 110. Further, users, such as borrowers, may apply for one or more financial accounts, and receive results of the application, via the website(s). In certain aspects, financial service provider 110 may be considered a lender, but separate from lenders 120 (i.e., lender 120A, 120B).

In certain aspects, a user 112 may operate one or more components of financial service provider (e.g., server 111) to perform one or more operations consistent with the disclosed embodiments. In one aspect, user 112 may be an employee of, or associated with, financial service provider 110 (e.g., someone authorized to use components of server 111 or perform processes for financial service provider 110). In other aspects, user 112 may not be an employee of, or otherwise associated with, financial service provider 110, but has access to server 111 or other components of financial service provider 110.

Client device 151 may be one or more computing devices that are configured to execute software instructions for performing one or more operations consistent with the disclosed embodiments. Client device 151 may be a desktop computer, a laptop, a server, a mobile device (e.g., tablet, smart phone, etc.), or any other type of computing device. Client device 151 may include one or more processors configured to execute software instructions stored in memory, such as memory included in client device 151. Further, client device 151 may include software that, when executed by a processor, performs known Internet-related communication and content display processes. For instance, client device 151 may execute browser software that generates and displays interfaces including content (e.g., content provided via a website associated with lender(s) 120 and/or financial service provider 110) on a display device included in, or connected to, client device 151. The disclosed embodiments are not limited to any particular configuration of client device 151. For instance, client device 151 may be a mobile device that stores and executes mobile applications that provide financial service related functions offered by financial service provider 110 and/or lender(s) 120, such as a mobile banking application for applying for financial accounts, such as credit card accounts, lines of credit, loans, etc.

In one embodiment, a user 150 may use client device 151 to perform one or more operations consistent with the disclosed embodiments. In one aspect, user 150 may be a customer of financial service provider 110 and/or one or more lenders 120 (e.g., lenders 120A, 120B). In other embodiments, user 150 may be a potential customer of financial service provider 110 and/or lender(s) 120, or user 150 may not be affiliated with financial service provider 110 and/or lender(s) 120 from the user's perspective and/or the financial service provider 110's and/or lenders 120's perspectives. User 150 may be a representative of an entity, such as a business, organization, partnership, etc.

In certain embodiments, system 100 may include a plurality of client device(s) 151 and associated user(s) 150. Further, user 150 may represent a borrower, consistent with the disclosed embodiments. A borrower may include, for example, a user (or entity) that holds one or more financial accounts (e.g., a line of credit, credit card, loan, etc.) from a lender (e.g., lenders 120, financial service provider 110, etc.). A borrower may also include, for example, a user (or entity) that is seeking or has sought one or more financial accounts from a lender (e.g., lenders 120, financial service provider 110, etc.). For example, user 150 may be a borrower that is applying, may apply, or has applied for a loan or other type of financial account from one or more lenders (e.g., lenders 120, financial service provider 110, etc.) that was approved, modified, or denied. For instance, user 150 may hold a line of credit with a first lender (e.g., financial service provider 110) and is applying, or has applied, for a loan (or other type of financial account) offered by the same first lender or another separate lender (e.g., financial service provider 110 or lenders 120A, 120B, etc.

Lender 120 (FIG. 1 shows two exemplary lenders 120A, 120B) may be an entity that offers one or more financial accounts. Thus, as disclosed herein, lender 120A or 120B (or any other lender consistent with the disclosed embodiments) may be generally referred to lender 120. In one embodiment, lender 120 may be a financial service provider that offers different types of financial accounts (e.g., credit card accounts, checking accounts, loans, etc.). In other embodiments, a lender 120 may be an entity that provides other business services or products, but also offers one or more financial accounts to borrowers. For example, lender 120 may be a business that sells products or services online and/or via brick and mortar locations and also offers private label credit cards (e.g., a retail store, etc.) or similar financial accounts that borrowers may apply to receive and use to purchase products or services from lender 120. While aspects of the disclosed embodiments relating to FIG. 1 may be described in connection with two lenders 120A and 120B, the disclosed embodiments may be implemented in a system including one or more lenders 120. Further, lender 120 (and financial service provider 110) is not limited to conducting business in any particular industry or field. For example, lender 120A may be a bank that offers financial accounts to borrowers and lender 120B may be a retail company that sells products and/or services, and also provides one or more financial accounts (e.g., private label credit accounts).

In certain embodiments, lender 120 may be a service entity that provides services to users and offers financial accounts in the form of service accounts reflecting invoices or bills for such services (e.g., a utility company, Internet provider, telephone company, etc.). In these embodiments, a financial account may include service accounts that may be offered to a borrower (e.g., user 150) for certain services provided by lender 120 to the borrower (e.g., utility company). For example, user 150 may apply for a service account from lender 120 (that may be a service entity) and lender 120 (e.g., a service entity) may analyze and determine whether to approve the request. The service account lender 120 may offer the service account to an approved user 150 by maintaining a service account reflecting the user 150's use of the offered services and invoicing and receiving payments on the service account. A borrower may apply for such financial accounts (e.g., service accounts) offered by the service entity lender 120 consistent with those operations for other types of lenders 120 and financial accounts (e.g., a bank offered line of credit, etc.).

In certain embodiments, a lender (e.g., financial service provider 110, lenders 120) may offer a financial account by providing an opportunity to a borrower (e.g., user 150) to apply for a financial account provided by that lender, which may be approved, modified, or denied. A lender (e.g., financial service provider 110, lenders 120) may also offer a financial account by providing the account to the borrower after approval by the lender or some other entity or system. A lender (e.g., financial service provider 110, lenders 120) may offer one or more financial accounts (e.g., loans, lines of credit, etc.) to one or more borrowers (e.g., user(s) 150).

Lender 120 may include brick and mortar location(s) that a borrower (e.g., user 150) may physically visit and request approval of offered financial accounts. Such physical locations may include computing devices that perform financial service transactions with borrowers (e.g., POS terminal(s), kiosks, etc.). They may also include back- and/or front-end computing components that store data and execute software instructions to perform operations consistent with disclosed embodiments, such as computers that are operated by employees of lender 120 (e.g., back office systems, etc.). In certain embodiments, lender 120 may also include entities that offer financial accounts through online technologies, such as a website or similar online location that borrowers may access using a computer through browser software or similar software (e.g., browser software on client device 151).

In one embodiment, lender 120 may include a lender system 121. FIG. 1 shows exemplary lenders 120A and 120B including lender systems 121A and 121B, respectively. Lender system 121 may include one or more computing devices configured to execute software instructions stored in memory to perform one or more processes consistent with the disclosed embodiments. For example, lender system 121 may include one or more memory device(s) storing data and software instructions and one or more processor(s) configured to use the data and execute the software instructions to perform server-based functions and operations known to those skilled in the art. Lender system 121 may also be configured to execute stored software instructions to perform operations associated with lender 120, including one or more processes associated with offering financial accounts and other operations, such as accounting, banking operations, and providing lender information to financial service provider 110 or another component connected to network 140 (e.g., third-party lender information aggregator configured to collect lender information consistent with the disclosed embodiments). Lender system 121 may include a standalone computing system (e.g., a server, a server connected to or including memory, etc.), or it may be part of a subsystem, which may be part of a larger system. For example, server 151 may represent distributed servers that are remotely located and communicate over a network (e.g., network 140) or a dedicated network, such as a LAN, for merchant 150.

In certain aspects, lender system 121 may include web server software that generates, maintains, and provides web site(s) for a respective lender 120 (e.g., lender 120A, 120B) that is accessible over network 140. In other aspects, lender system 121 may connect separate to web server(s) or similar computing devices that generate, maintain, and provide web site(s) for lender 120. For example, lender 120A may include, use, or connect to one or more web server(s) that provide a web site specific to lender 120A, and allows the user to access, view, apply, and manage financial accounts offered by lender 120A.

In certain embodiments, one or more users may operate components associated with lender 120 to perform one or more processes consistent with the disclosed embodiments. For example, a user 122A may access, use, and otherwise operate lender system 121A of lender 120A to perform processes such as, generating, providing, and analyzing requests for financial accounts from borrowers. User 122B may also access, use, and otherwise operate server 121B of lender 120B to perform similar processes associated with the business for lender 120B.

Credit assessor 130 may be an entity that performs credit assessments for consumers. For example, credit assessor 130 may be an entity that provides credit evaluation services to consumers (e.g., user 101) and/or financial service related entities (e.g., merchants 150 and financial service provider 110). In one example, credit assessor 160 may be an entity that provides credit scores to a consumer (e.g., user 101) based on the credit history for that consumer. Credit assessor 130 may also provide credit assessments to financial service provider 110 for borrowers attempting to apply for financial service accounts offered by financial service provider 110 and/or lenders 120A, 120B. Credit assessor 130 may also be configured to execute software processes that provide credit check information relating to borrowers who previously applied for, holds, or previously held, financial accounts offered by financial service provider 110 and/or lenders 120A, 120B. A borrower may hold a financial account by, for example, being associated with a financial account by the lender that offered the account to that borrower. Credit assessor 130 may include computing components known to those skilled in the art to provide credit check and assessment services and to provide information relating to the credit check and assessment services over network 140, such as a web server providing a web site accessible by user 101 or a server that communicates with server 111 and/or servers 151A and/or 151B. Credit assessor 130 may include credit assessor system 131. The disclosed embodiments are not limited to any particular configuration of the computing components used by credit assessor 160.

In certain aspects, lending system 130 may include components that provide an online portal that provides a mechanism for small businesses 150 to request and send data that is used for performing one or more operations of the disclosed embodiments. Lending system 130 may include one or more web servers that generate, maintain, and manage web site pages that provide interfaces that are accessed by users, such as users 152A and/or 152B, using browser software executing in the computing components of server 151.

Network 140 may be any type of network configured to provide communications between components of system 100. For example, network 100 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and small business 150B and between financial service provider 110 and lending system 130.

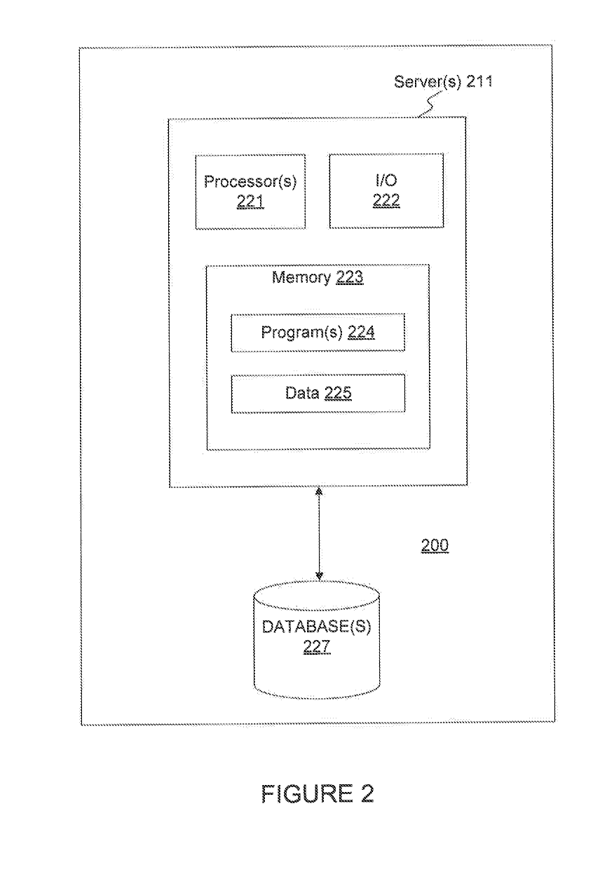

FIG. 2 shows an exemplary system 200 that may be associated with financial service provider 110, such as server 111 or another computing system included with or associated with financial service provider 110. In other embodiments, system 200 shown in FIG. 2 and described below may reflect a system or components included in or associated with lender(s) 120, credit assessor 130, and/or client device 151. For example, system 200 may reflect one or more components of server 111, lender system 121, or credit assessor system 131. Accordingly, the description below regarding system 200 may be applicable to systems and components associated with or included in any of the components of system 100 of FIG. 1.

In one embodiment, the system may include a server 211 having one or more processors 221, one or more memories 223, and one or more input/output (I/O) devices 222. Server 211 may take the form of a general purpose computer, a mainframe computer, or any combination of these components. In certain embodiments, server 211 (or a system including server 211) may be configured as a particular apparatus, system, and the like based on the storage, execution, and/or implementation of the software instructions that perform one or more operations consistent with the disclosed embodiments. Server 211 may be standalone, or it may be part of a subsystem, which may be part of a larger system.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to the disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider 110, via server 211, may access one or more remote programs that, when executed, perform functions related to certain disclosed embodiments.

Memory 223 may also store data 225 that may reflect any type of information in any format that financial service provider 110 may use to perform financial service provider functions. For example, data 225 may include business records associated with customers of financial service provider 110 (e.g., user 150). In certain aspects, memory 223 may store software instructions that, when executed by one or more processors 221, may perform operations consistent with the disclosed embodiments. For example, program(s) 224 may include software instructions that process requests for financial accounts from user(s) 150 based on, for example, lender information that may be received by financial service provider 110 in a manner consistent with the disclosed embodiments. Program(s) 224 may also include software instructions that evaluate lenders 120 based on received lender information consistent with the disclosed embodiments. For example, financial service provider 110 may determine, based on received lender information, whether to form a business relationship with lender 120A based on lender information relating to borrowers of financial accounts offered by lender 120A.

I/O devices 222 may be one or more devices configured to allow data to be received and/or transmitted by server 220. I/O devices 222 may include one or more digital and/or analog communication devices that allow server 211 to communicate with other machines and devices, such as components of system 100.

Server 211 may also be communicatively connected to one or more database(s) 227. Server 211 may be communicatively connected to database(s) 227 through network 140 or through another communication path. Database 227 may include one or more memory devices that store information and are accessed and/or managed through server 211. By way of example, database(s) 211 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, financial service provider 110 (or lender system 120 or credit assessor 130) may include database 227. Alternatively, database 227 may be located remotely from such components. Database 227 may include computing components (e.g., database management system, database server, etc.) configured to receive and process requests for data stored in memory devices of database(s) 227 and to provide data from database 227.

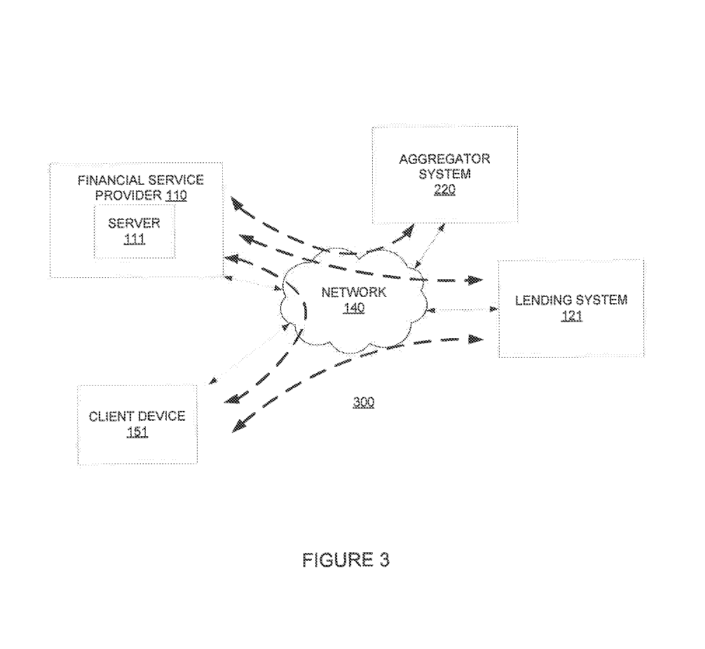

FIG. 3 shows a block diagram of an exemplary system 300 relating to a process of requesting, sending, and/or receiving lending information consistent with some disclosed embodiments. In this example, FIG. 3 shows system 300 including financial service provider 110, lending system 121 (included in lender(s) 120), and client device 151, although the description of FIG. 3 is applicable to systems including lending system 121 and client devices 151 respectively associated with lenders 120, clients 151, and/or financial service providers 110.

In certain embodiments, server 111 is configured to process lender information to determine whether to approve requests for financial accounts by user 150 via client device 151 (or through other means such as telephonic technologies). In one aspect, client device 151 may be configured to send a request for a financial account offered by financial service provider 110 to server 111 through, for example, network 140. Client device 151 may also be configured to send, based on, for example, input from user 150, one or more requests for financial account(s) offered by one or more lenders 120 (e.g., lender 120A, 120B) via network 140.

Lending system 121, which may reflect one or more lending systems 121 respectively associated with different lenders 120, may execute software processes to process the financial account requests from client device 151 to determine whether to approve, modify and approve, or decline the financial account requests. Lending system 121 may be configured to process financial account request using known financial account assessment processes, such as collecting and analyzing credit information associated with the requesting user 150, collecting and analyzing credit score information from credit assessor 130, etc. Lending system 121 may store information relating to the user 150's financial account request(s), and any financial account(s) approved or declined or modified by lender 120 associated with lending system 121. Lending system 121 may compile information relating to the financial account requests and approved and/or declined financial accounts associated with users 150, and store this information as lending information for each user 150.

In one embodiment, lender information may include, for example: (1) the identity of the lender 120; (2) spending activity of a user 150 on approved financial account(s) offered by the lender 120; (3) spending activity of a user 150 on non-credit financial accounts offered by the lender 120 (e.g., savings accounts, checking accounts, etc.); (4) the identity of financial accounts approved to a user 150 by the lender 120; (5) the identity of financial accounts declined to a user 150 by the lender 120; (6) one or more parameters of the approved and/or declined financial accounts to a user 150 by the lender 120 (e.g., credit limit, outstanding balance, interest rate(s), penalty fees, penalty fees assessed to the user 150, penalty fees paid by the user 150, etc.); (7) repayment information by a user 150 for each financial account offered to the user by the lender 120 (e.g., frequency of payments, missed payments, amount of payments, minimum payments made, average minimum payment, etc.); frequency of new financial accounts granted by the lender 120 to a user 150; (8) time from last financial account approved by the lender 120 to a user 150; (9) utilization of financial accounts offered by the lender 120 to a user 150, and/or any other information relating to financial accounts offered, approved, modified, and/or declined by the lender 120 to a user 150.

In certain embodiments, financial service provider 110 (via e.g., server 111) may request and receive lender information associated with one or more borrowers (e.g., user 150) from one or more lending systems 121 of lenders 120. In one embodiment, server 111 may request and receive lender information for one or more borrowers from lending system 121 over network 140. In other embodiments, server 111 may collect lender information maintained by lending system 121 indirectly, such as through an aggregator system 220.

In other embodiments, lender information may be collected, compiled and stored by other systems based on collecting financial account data for borrowers (e.g., users 150) from lending systems 121 associated with lenders 120. For example, financial service provider 110, via server 111 or another component, may be configured to request and receive credentials (e.g., financial account number, user identification, passwords, etc.) from a borrower (e.g., user 150), via client device 151, that enable server 111 to access financial account data associated with the borrower maintained by a lender 120. For example, server 111 may execute software processes that use the borrower's credentials to access financial account data through a website or similar online location (via, e.g., the Internet) provided by the lender 120 that offers financial account(s) to the borrower. For instance, user 150 may send financial service provider 110 account numbers, user identification, and/or password information that enables server 111 to automatically access online banking services provided by a lender 120. In some embodiments, server 111 may obtain (e.g., via computing devices associated with the borrow) credentials for accessing financial account data via screen scraping during a user log-in procedure, keystroke logging during a log-in procedure, accessing password files store on one or more borrower computing device(s), etc. Server 111 may collect financial account data for user 150 associated with financial accounts offered by the lender 120 to user 150. Server 111 may be configured to process the collected financial account data to generate lender information for the user 150 in relation to the lender 120.

In another aspect, financial service provider 110 may collect lender information from aggregator system 220, which may be a system configured to request, receive, generate, and/or store lender information for borrowers associated with one or more lenders 120 (via, e.g., lending systems 121) and provide the lender information to financial service provider 110, sometimes for a fee.

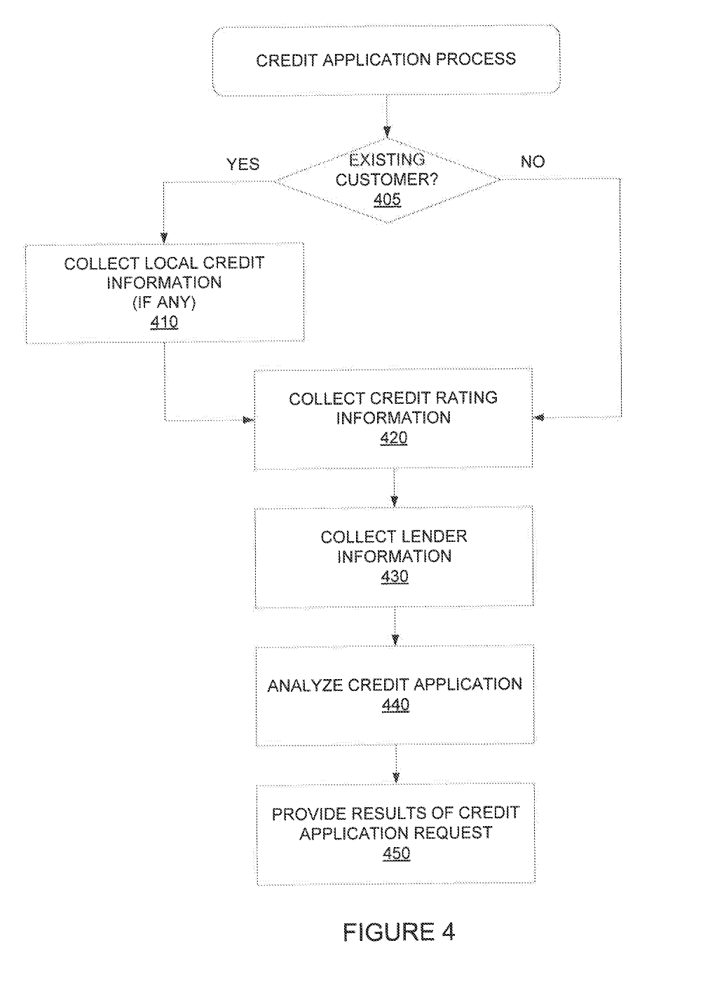

FIG. 4 is a flowchart of an exemplary credit application process consistent with disclosed embodiments. In one aspect, server 111 may be configured to perform one or more of the steps of the flowchart of FIG. 4. The disclosed embodiments are not limited to the sequence or performance of all of the steps of FIG. 4. One or more of the steps may be excluded or additional processes included consistent with the disclosed embodiments. In one embodiment, server 111 may receive a request from a borrower (e.g., user 150, via client device 151) for a financial account offered by financial service provider 110. The request may be for a new financial account or a modification of an existing account (e.g., a credit line increase, etc.). Server 111 may determine based on the request whether the borrower is an existing customer of financial service provider 110 (step 405). If not, the process may continue to step 420. If, however, the borrower is an existing customer, server 111 may collect local credit information associated with the borrower, if any exists with financial service provider 110 (step 410). In one aspect, local credit information may include any information relating to financial accounts offered, approved, or declined by financial service provider to the borrower (e.g., account activities, previous financial account application information, balances, penalty fees, and any other financial account information known to one of ordinary skill in the art that can be used to assess the credit worthiness of the borrower).

In one embodiment, server 111 may also collect credit rating information (step 420). Server 111 may generate and send a request for credit rating(s) associated with the borrower from, for example, credit assessor 130. Server 111 may receive the credit rating information from credit assessor 130, which may include known credit score or similar rating information known to those skilled in the art (e.g., FICO score data, etc.).

In another embodiment, server 111 may collect lender information (step 430). In one aspect, the lender information may be associated with the borrower and/or any lender(s) 120 that offer or had offered, declined, approved, etc. to the borrower. In other aspects, the lender information may be associated with or associated with one or more other borrowers and/or other lenders 120. For example, the collected lender information may be associated with other borrower(s) having similar characteristics or profiles as the requesting borrower. Server 111 may collect lender information from a memory associated with financial service provider 110 or server 111, such as previously collected lender information from one or more lenders 120 for the borrower or other borrowers and associated lenders 120. Server 111 may also collect the lender information at the time of processing the financial account request for the requesting borrower. Server 111 may also be configured to collect lender information based on a combination of these processes (e.g., collect some previously collected and stored lender information and request and receive lender information from lender(s) 120 in response to the request for the financial account by the requesting borrower.

Server 111 may execute software instructions that analyze the credit application for the requesting borrower (step 440). In one embodiment, server 111 may analyze the credit application based on the local credit information (if any), the credit rating information (if any), and/or the lender information collected in step 430. Server 111 may analyze the credit application based on the information to determine the credit worthiness of the requesting borrower and determine whether to approve, decline, or modify the financial account offered to the borrower. The disclosed embodiments may implement and perform processes, algorithms, etc. known to those skilled in the art to determine the credit worthiness of the borrower. In addition, or alternatively, server 111 may be specifically configured to execute software processes that use the lender information to assess the credit worthiness of the borrower.

Based on the results of the analysis, and in certain embodiments, based on the lender information associated with the requesting borrower, the lender(s) 120 that offered financial accounts to the requesting borrower, and/or with other borrower(s) and other lender(s) 120, server 111 may generate a determination that the requested financial account (or modification to an existing financial account) offered by financial service provider 110 is approved or declined (or modified). Server 111 may generate and provide the results of the credit application request (Step 450). For example, server 111 may generate a notification that is provided to user 150, via, for example client device 151, or through other communication mechanisms. The notification may be, for example, an email, text message, automated telephonic message, a hyperlink to a webpage or similar online location that provides the notification, etc.

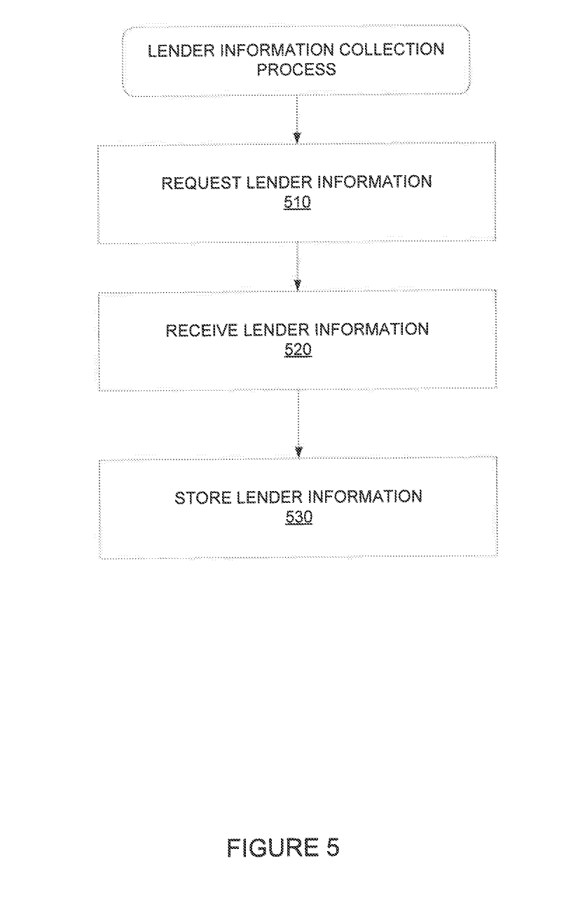

The disclosed embodiments may collect lender information in different ways. FIG. 5 shows a flowchart of exemplary lender information collection process consistent with certain disclosed embodiments. Also, lender information collected, received, and/or stored consistent with the disclosed embodiments may include one or more types of lender information as exemplified above. That is, for example, the type of lender information collected by server 111 from one source (e.g., lender 120A) may include the same and/or different types of lender information collected from another source (e.g., lender 120B). In one aspect, server 111 may be configured to generate and send a request for lender information to a component that maintains such information (e.g., lender(s) 120, aggregator system 220, etc.) (step 510). Server 111 may receive the requested lender information (step 520) and store the lender information in one or more memories (step 530). Server 111 may be configured to access the stored lender information to perform one or more operations consistent with the disclosed embodiments, such as analyzing credit applications or analyzing lender information for assessing lender(s) 120, etc.

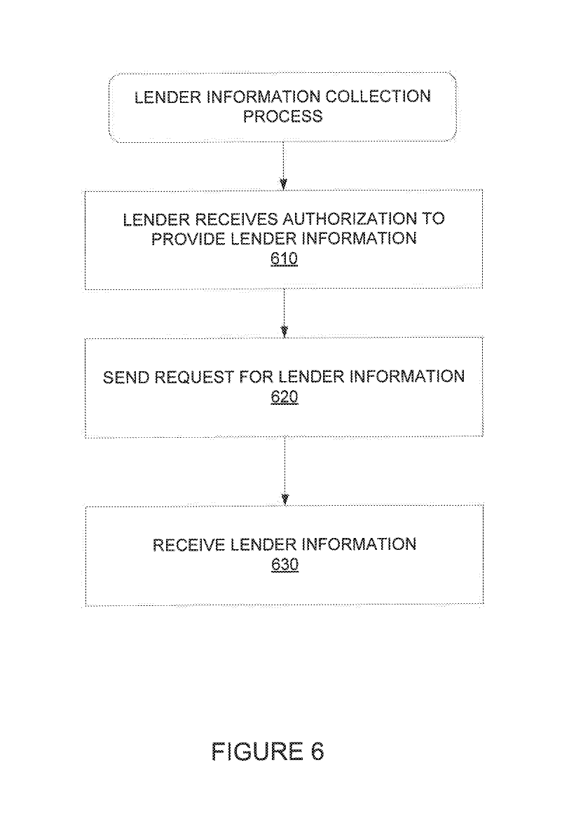

FIG. 6 shows a flowchart of another exemplary lender information collection process consistent with certain disclosed embodiments. In this example, a lender 120 may receive authorization from a borrower (e.g., user 150) who holds one or more financial accounts offered by the lender 120 (step 610). The authorization may reflect the borrower's agreement to allow the lender 120 to provide lender information associated with the borrower to another component or entity, such as financial service account 110. In one aspect, financial service account 110, via server 111 or another component, may generate and send a request to the borrower to request that the borrower authorize the lender 120 to provide the lender information for that borrower to financial service account provider 110. In one aspect, financial service provider 110 (e.g., server 111) may send a request to the lender 120 for the lender information. Based on the authorization granted by the borrower, the lender 120 may compile and send lender information associated with the borrower to financial service provider 110. Server 111, for example, may receive and store the received lender information (step 630).

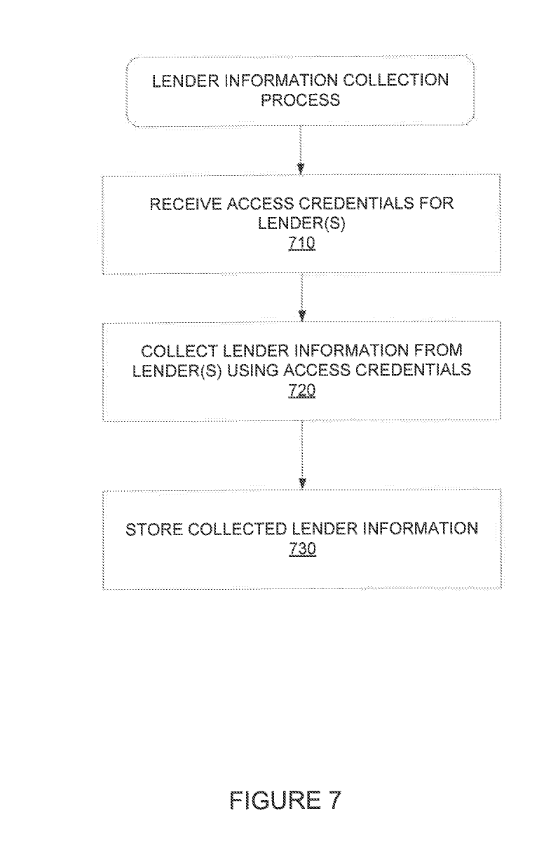

FIG. 7 shows another example of a lender information collection process consistent with certain disclosed embodiments. In one aspect, financial service provider 110 may request and receive access credentials from a borrower (e.g., user 150, via client device 151) for one or more lender(s) 120, similar to the credentials disclosed above (step 710). Server 111 may use the credentials to access financial account information from the lender(s) 120 to collect lender information, similar to that described above (step 720). Server 111 may receive and store the collected lender information from the one or more lender(s) 120 (Step 730).

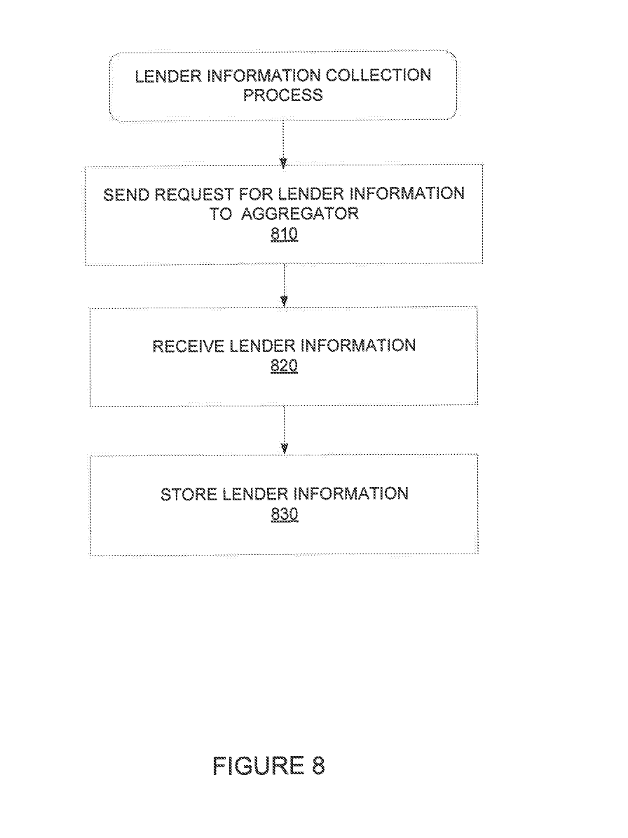

FIG. 8 shows another example of a lender information collection process consistent with certain disclosed embodiments. In this example, server 111 may generate and send a request for lender information for one or more borrower(s) or one or more lender(s) 120, or a combination of borrower(s) and/or lender(s) 120, to an aggregator (e.g., aggregator system 220) (step 810). In response to the request, server 111 may receive the requested lender information from the aggregator (step 820). Server 111 may store the collected lender information in one or more memories (step 830).

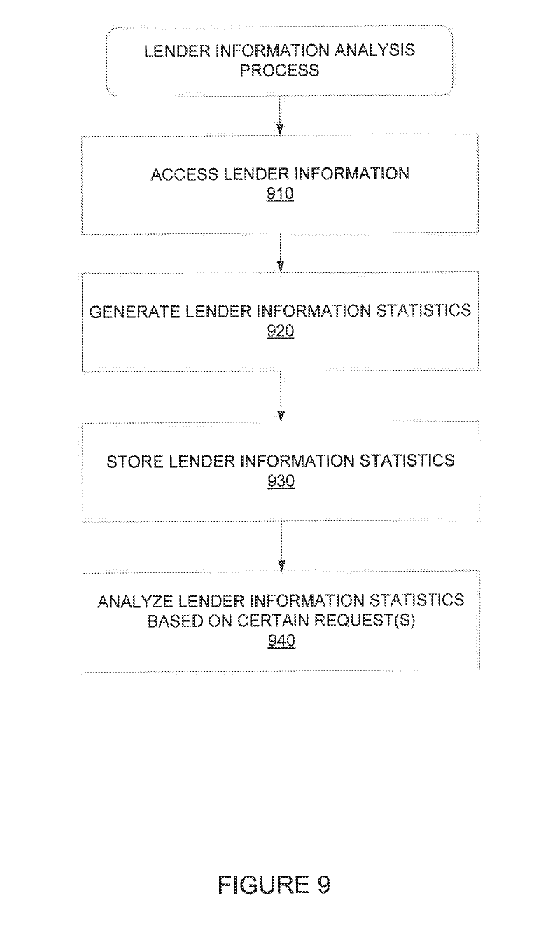

FIG. 9 shows a flowchart of an exemplary lender information analysis process consistent with certain disclosed embodiments. In one aspect, server 111, or another component, may execute software instructions that access lender information (step 910). In one embodiment, server 111 may access lender information that has been collected and stored in one or more memories of financial service provider 110. The lender information may include lender information associated with one or more lenders 120 and borrowers associated with those lenders 120. For example, server 111 or another component, may store lender information for specific lenders (e.g., 120A, 120B, etc.) in data structures that are searchable and accessible by server 111. For example, database 227 may store data structures for individual lenders 120 that include lender information relating to those specific lenders 120. The lender information may have been previously collecting in accordance with the lender collection processes consistent with the disclosed embodiments. Database 227 may store the lender information in segments based on borrower profile data (e.g., demographics, financial account characteristics, etc.), lender 120 characteristics (e.g., geographic regions, lender type (e.g., bank, credit card company, mortgage provider, etc.), and/or financial account profile data (e.g., size of account, types of accounts, payment activity of accounts, etc.).

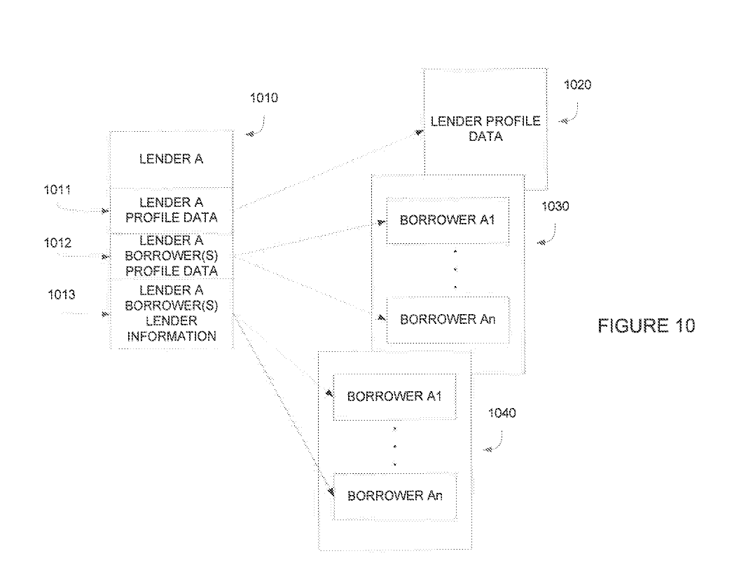

FIG. 10 shows an example of data structures that database 227 or another memory may store consistent with certain disclosed embodiments. The data structures may include lender A information 1010. Lender A information may include lender A profile data 1011, lender A borrower(s) profile data 1012, and lender A borrower(s) lender information 1013. Lender profile data 1011 may include lender profile data 1020. Lender A borrower(s) profile data 1012 may include profile data for borrowers A1 to An (1030). Lender A borrower(s) lender information 1013 may include lender information for borrowers A1 to An (1040). However, the disclosed embodiments are not limited to any particular format, configuration, and the like of the data structures, memories, etc. of the lender information stored and used by server 111 or any other component of the disclosed embodiments.

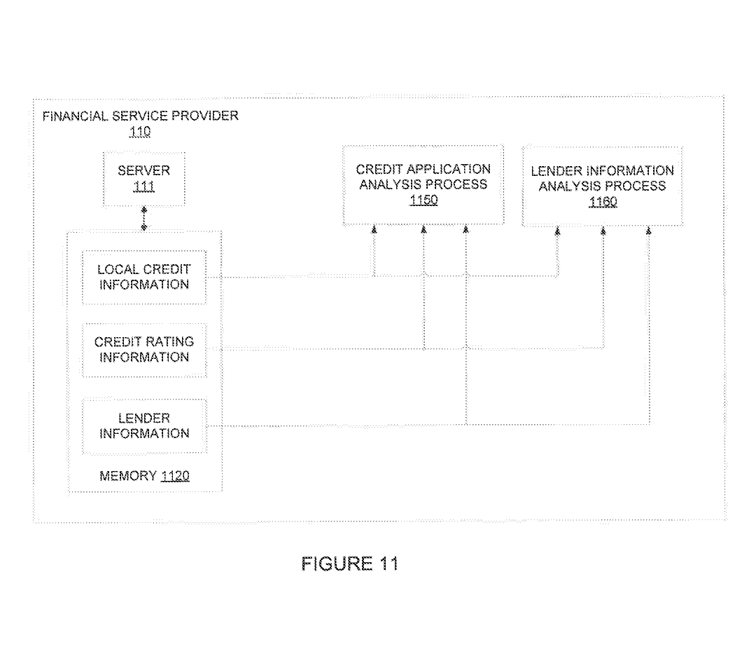

FIG. 11 shows an example of a financial service account 110 system consistent with certain disclosed embodiments. For example, financial service provider 110 may include server 111 connected to a memory 1120 (e.g., database 227 or other memory) that stores local credit information, credit rating information, and lender information consistent with the disclosed embodiments. In one aspect, the lender information may be stored as disclosed above. Financial service provider 110 may also include credit application analysis process 1150 and lender information analysis process 1160, which may be software programs including software instructions stored in a memory or memories (e.g., memory 223) that server 111 may execute to perform the credit application analysis and lender information analysis processes disclosed herein. Processes 1150 and 1160 may use the local credit information, credit rating data and/or the lender information to perform their respective processes consistent with the disclosed embodiments.

The disclosed embodiments may also be configured to allow financial service provider 110 to (via server 111) to generate statistical information relating to borrowers who may or may not be customers of financial service provider 110 and/or lenders 120. The disclosed embodiments may be implemented to allow financial service provider 110 (e.g., server 111) to assess the credit worthiness of a borrower based on the statistics, heuristics, etc. generated based on the lender information. For example, server 111 may be configured to incorporate, consider, use, etc. the lender information-based statistics, heuristics, etc. in lending decisions for borrowers. For instance, when new customers of financial service account provider apply for a loan, server 111 may be configured to generate and request from the customers information about which lenders have already lent and/or are currently lending money to them. Server 111 may use this information to assess the credit worthiness of the borrowers by accessing and using the statistics and heuristics generated based on the lender information as disclosed herein. In another example, when existing customers of financial service provider 110 request a credit line increase or when server 111 determines with a request from a customer that a customer is eligible for a credit line increase, server 111 may request and receive lender identity information from those customers. Server 111 may incorporate, use, consider, etc. the lender information-based statistics, heuristics, etc. in determining whether to extend their respective credit lines and by how much.

Server 111 may also use the statistical information to evaluate lender(s) 120 for various purposes, such as to determine whether financial service provider 110 should acquire a lender 120, whether to partner with a lender 120, or engage in other business actions with a lender 120. For instance, server 111 may be configured to generate one or more regression and/or event study information that reflect credit/spending performance based on specific lender(s) 120. For instance, server 111 may execute software instructions that may use this and other statistical information generated by the lender information to determine patterns or characteristics associated with particular lenders or groups of lenders based on the profiles of their respective borrowers or the financial accounts approved, declined, etc. to borrowers. For example, server 111 may determine from regressions performed on the lender information that: (1) lender 120A extends a certain percentage (e.g., 20%) more generous credit lines to borrowers having FICO scores of a certain value (e.g., greater than 670); (2) lender 120B approves credit line increases of a certain percentage or amount (e.g., 30%) more frequently for borrowers who reside in a certain geographic area (e.g., a certain state, city, zip code, region, etc.); (3) smaller lender types (e.g., small banks/lenders) approve credit lines to a disproportionate share of borrowers with income levels below a certain amount (e.g., below $50,000 per year); (4) when a particular lender (e.g., lender 120A) approves credit line increases to borrowers, that results in a proportional increase in spend on that lender's credit and other accounts (e.g., debit accounts); and/or (5) borrowers of a specific lender (e.g., lender 120B) are delinquent a certain amount (e.g., 40%) less often when that lender approves a certain amount of credit (e.g., extends a $1,000 credit line) to those borrowers. Other determinations may be generated and the examples and values and conditions disclosed above are exemplary and are not limiting to the disclosed embodiments.

Server 111 may be configured to monitor the results of financial account request decisions of borrowers of financial service provider 110 and use the results to refine the statistics and heuristics generated based on the lender information for future lender and borrower analysis and financial account decisions.

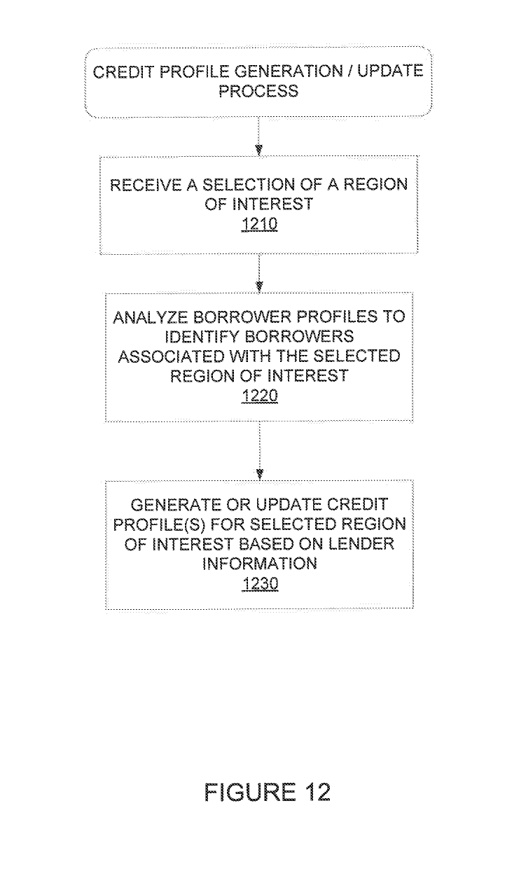

FIG. 12 shows a flowchart of an exemplary credit profile generation/update process consistent with disclosed embodiments. In one aspect, server 111 may receive a selection of a region of interest (e.g., a geographic region, etc.) from, for example, user 112 (step 1210). Server 111 may analyze borrower profiles (of financial account provider 110) to identify borrowers associated with the selected region of interest (e.g., a state, county, city, town, zip code, etc.) (step 1220). Server 111 may analyze the lender information associated with the identified borrowers to collect data regarding the particular lenders 120 associated with those borrowers to update credit profiles for the selected region of interest. Thus, for example, server 111 may generate and store profile information regarding lenders 120, borrowers, etc. in particular regions for use in analyzing requests for financial accounts or lenders 120 as disclosed herein.

In other embodiments, server 111 may be configured to generate lender relationship graphs that may be graphically presented to a user (e.g., user 112) that show user-friendly relationships between lenders 120 and borrowers who held or hold financial accounts with those lenders 120. For example, server 111 may use the lender information stored in a memory, such as, for example, the data structures disclosed above in connection with FIGS. 9-11, to generate graphical representations of which lenders 120 offer or offered financial accounts to specific borrowers. In certain aspects, the graphical representations may be generated in the form of nodal graphs or similar representations that may be searchable. Further, the information in each graph may be selectable by the user to provide additional information, such as, for a lender 120 or a borrower. Server 111 may execute software processes that respond to such exemplary selections to access the data structures or similar stored information relating to the lender information to generate additional graphical representations showing the requested information.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Moreover, the disclosed embodiments may implemented with any type of financial service accounts, and are not limited to financial loan or credit type accounts. Moreover, one or more processes associated with the disclosed embodiments may be performed by one or more processors executing software instructions. The disclosed embodiments may be configured to generate one or more interfaces that are provided by a server that is configured to generate web-based interfaces that include content, hyperlinks, and the like, known to one of ordinary skill in the art. The interfaces associated with the disclosed embodiments may be displayed via a display device included in a computing system associated with one or more of the client device 151, server 111, financial service provider 110, and/or other components of system 100. The components that receive and display the interfaces associated with the disclosed embodiments may be rendered by software instructions executed by one or more processors configured to generate and display such interfaces, as is known to those skilled in the art (e.g., browser software, etc.).

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A system for assessing financial account application requests, comprising:
one or more memory devices storing software instructions; and
one or more processors configured to execute the software instructions to:
receive a request from a borrower for a first financial account offered by a financial service provider,
collect first lender information associated with the borrower and a first lender, where the lender information includes information associated with at least one first lender financial account offered by the first lender to the borrower,
analyze the request based on the lender information, and
determine whether to approve the request for the first financial account based on the analysis.

2. The system of claim 1, wherein the first lender information includes information reflecting that the first lender declined the first lender financial account to the borrower.

3. The system of claim 1, wherein the first lender financial account is an existing financial account held by the borrower and provided by the first lender.

4. The system of claim 1, wherein the one or more processors are further configured to collect second lender information associated with the borrower and a second lender, wherein the second lender information includes information associated with at least one second lender financial account offered by the second lender.

5. The system of claim 4, wherein the second lender information includes information reflecting that the at least one second lender financial account was declined to the borrower.

6. The system of claim 4, wherein the second lender financial account is an existing financial account held by the borrower and provided by the second lender.

7. The system of claim 1, wherein the one or more processors are further configured to:
determine whether the borrower is an existing customer of the financial service provider;
collect local credit information associated with the borrower and the financial service provider;
analyze the request based on the lender information and the local credit information; and
determine whether to approve the request for the first financial account based on the analysis.

8. The system of claim 1, wherein the one or more processors are further configured to:
collect second lender information associated with a second borrower and a second lender;
analyze the request based on the lender information and the second lender information; and
determine whether to approve the request for the first financial account based on the analysis.

9. The system of claim 1, wherein the one or more processors are further configured to:
determine lender characteristics associated with the first lender based on the lender information.

10. The system of claim 1, wherein the one or more processors are further configured to:
collect lender information from a set of lenders that offer financial accounts to other borrowers;
determine lender characteristics associated with the set of lenders based on the collected lender information for the set of lenders; and
evaluate a specific lender based on the lender characteristics associated with the set of lenders.

11. A computer-implemented method for assessing financial account application requests, comprising:
receiving, by one or more processors, a request from a borrower for a first financial account offered by a financial service provider;
collecting, by the one or more processors, first lender information associated with the borrower and a first lender, where the lender information includes information associated with at least one first lender financial account offered by the first lender;
analyzing, by the one or more processors, the request based on the lender information; and
determining, by the one or more processors, whether to approve the request for the first financial account based on the analysis of the request.

12. The method of claim 10, wherein the first lender information includes information reflecting that the first lender declined the first lender financial account to the borrower.

13. The method of claim 10, wherein the first lender financial account is an existing financial account held by the borrower and provided by the first lender.

14. The method of claim 10, further comprising:
collecting, by the one or more processors, second lender information associated with the borrower and a second lender, wherein the second lender information includes information associated with at least one second lender financial account offered by the second lender.

15. The method of claim 14, wherein the second lender information includes information reflecting that the at least one second lender financial account was declined to the borrower.

16. The method of claim 14, wherein the second lender financial account is an existing financial account held by the borrower and provided by the second lender.

17. The method of claim 10, further comprising:
determining, by the one or more processors, whether the borrower is an existing customer of the financial service provider;
collecting, by the one or more processors, local credit information associated with the borrower and the financial service provider;
analyzing, by the one or more processors, the request based on the lender information and the local credit information; and
determining, by the one or more processors, whether to approve the request for the first financial account based on the analysis.

18. The method of claim 10, further comprising:
collecting, by the one or more processors, second lender information associated with a second borrower and a second lender;
analyzing, by the one or more processors, the request based on the lender information and the second lender information; and
determining, by the one or more processors, whether to approve the request for the first financial account based on the analysis.

19. The method of claim 10, further comprising:
determining, by the one or more processors, lender characteristics associated with the first lender based on the lender information.

20. The method of claim 10, further comprising:
collecting, by the one or more processors, lender information from a set of lenders that offer financial accounts to other borrowers;
determining, by the one or more processors, lender characteristics associated with the set of lenders based on the collected lender information for the set of lenders; and
evaluating, by the one or more processors, a specific lender based on the lender characteristics associated with the set of lenders.
